(19) United States
(12) Patent Application Publication
(10) Pub. No.: US 2005/0043961 A1
(43) Pub. Date: Feb. 24, 2005

(54) System and method for identification, detection and investigation of maleficent acts

(76) Inventors: Michael Torres, Austin, TX (US); Blayne Maring, Austin, TX (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/673,911

(22) Filed: Sep. 29, 2003

Related U.S. Application Data
(60) Provisional application No. 60/414,802, filed on Sep. 30, 2002.

(51) Int. Cl. G06F 17/60

(52) U.S. Cl. 705/1

(57) ABSTRACT

The invention relates to enterprise software for enabling organizations to apply business intelligence in an operational environment by integrating real-time transactional data with remote and disparate historical data to achieve true enterprise intelligence for maleficent activity detection, such as fraud and threat detection. It enables a workflow process comprising classification of data in remote disparate databases for identity verification, arbitration of fuzzy differences between data sets for detection of maleficent acts, and investigation of relationships between people, places and events using refined search techniques, analytical tools and visualization methods. The invention receives, verifies and classifies transaction datasets into predefined categories, enables detection and arbitration of ambiguities in the datasets, investigates high risk datasets, enables transaction datasets in a low risk category and disables transaction datasets in a high risk category. Remote similarity search agents are used to search disparate databases to ensure privacy of the information in the disparate databases.

This application claims benefit of U.S. Provisional Application No. 60/414,802, filed on Sep. 30, 2002.

### BACKGROUND

The invention relates generally to means for transforming large amounts of stored data into knowledge useful for performing functions necessary to achieve goals of an enterprise. More particularly, the invention relates to enterprise software for enabling organizations to apply business intelligence in an operational environment by integrating real-time transactional data with remote and disparate historical data to achieve true enterprise intelligence for maleficent activity detection, such as fraud and threat detection. It provides an enterprise level solution to large-scale workflow processes for searching, analyzing and operating on transactional and historical data in remote and disparate databases in real time to uncover obvious and nonobvious relationships, apply analytical results in an operational environment, and interoperate with other enterprise applications. The invention enables a workflow process comprising classification of data in remote disparate databases for identity verification, arbitration of fuzzy differences between data sets for detection of maleficent acts, and investigation of relationships between people, places and events using refined search techniques, analytical tools and visualization methods.

Although the invention finds wide application in diverse environments for detection of maleficent activities, it is described in terms of application to threat and fraud detection through identification, detection and investigation based on information contained in disparate databases. Applications according to the present invention include insurance claims evaluation for detection and prevention of insurance fraud, transaction risk detection, identification verification for use in credit card processing and airline passenger screening, records keeping verification, and government list comparisons. Standard plug-in applications for use with the invention include similarity search agents for searching disparate databases and reporting search results, a classification engine for classifying transactions or search results, an analytic engine for analyzing results such as biometrics and providing inputs to a decision engine, a rules engine, a report engine, a link analysis engine for nonobvious relationship analysis, a method for arbitrating fuzzy differences between data, and a transformation server for virtualization of multiple disparate data sources. Customer applications may be readily integrated into the workflow process, which include cultural names data, report engines, rules engines, neural networks, decision trees and cluster engines.

When attempting to identify, detect, or investigate maleficent acts such as potential security threats or fraudulent claims activities, businesses and governmental entities face a number of problems. These include finding answers to the following questions:
Is an individual who he/she claims to be?
Is the individual a known terrorist or perpetrator of fraud?
Is the individual associated with a known criminal/terrorist/fraudulent group via a non-obvious relationship? and
Does the individual exhibit fraudulent/threatening behavioral patterns?
   Previously, organizations have employed labor-intensive manual processes to answer these questions. Typically, the process took place only after a fraudulent or threatening event had already occurred, resulting in a substantial number of threats and frauds that escaped detection due to the limited availability of trained investigators. Efforts to automate the process have been difficult and ineffective as previous commercial software solutions have been unable to resolve the ambiguities and falsifications that afflict data.

Organizations previously concerned with potential maleficent acts such as threats or frauds have employed workflows requiring human decision makers to evaluate input documents and steer them through the classification process. Commercial offerings for automating workflows were primarily designed for essentially closed, internal processes such as Customer Relationship Management (CRM) and have proven unworkable when the data is flawed, fuzzy or fraudulent. Investigative units rely on highly trained, seasoned personnel to identify possible threats or frauds, but such groups have limited capacity and can afford to pursue only the highest profile cases.

There is a need for means to identify and resolve a fraudulent or threatening event prior to its occurrence and to address the problems listed above. To accomplish this, a process must utilize investigative methodologies including but not limited to the following:
Identity verification;
Intelligent watch list matching;
Non-obvious relationship linking; and
Pattern or behavior modeling.
   A process to accomplish these objectives must combine the efficiency of automated processes in the front-end with the judgment of trained investigators in a hybrid classification workflow. The process must provide a fast and automated methodology for detecting and identifying maleficent activities such as threats or fraudulent behavior prior to an event occurring. It must also streamline an otherwise labor intensive, manual process.

Key requirements for such a process include an ability to uniquely solve the previously stated problems, as well as an ability to identify and detect maleficent activities such as threats and fraud before they occurs rather than afterwards, so that remediation and investigation activities can take place to prevent the occurrence of fraud and/or threat at an early stage. Also required is an ability to perform these functions in real time processing, near-real time processing, and batch processing for significantly large transaction sets by analyzing and dynamically filtering these transaction sets. In order to accomplish this, the process must be inherently scalable by instantiating multiple sub-processes of identity verification and detection, and must run in parallel to consolidate these procedures for final classification. The process must also provide the ability to manage the degree of false positives/false negatives that may occur. This requires a flexible process that would, for instance, allow zero false negatives for threats and an acceptably low level of false negatives for fraud. Finally, the process must have an ability to do all of the above as well as transfer the knowledge for human intervention in a timely manner so that action can be taken to resolve the maleficent acts such as fraud or threat before its occurrence.

### SUMMARY

The present software system and method is a process that integrates technologies drawn from the areas of transaction processing, document management, workflow management, and similarity search. It also encompasses methodologies of fraud investigation, counter-terrorism, and threat assessment. It enables users to automate the early stages of threat detection and investigation processes, while incorporating human judgment at critical decision points. It results in early resolution of cases where data is complete and reliable, but allows others to continue through more exhaustive data enhancement and arbitration procedures. The result is a more efficient workflow with automated procedures handling the routine classification decisions and human resources concentrated where they are most effective. The method is highly successful at screening threats to airlines and ports of entry as well as at identifying fraudulent insurance claims. The process model described here permits user organizations to deploy automated classification technologies in the early stages of document workflows. By automating the early stages of the workflow, the clear-cut cases that can be resolved by the automated facilities can be handled without the involvement of trained investigators, freeing them to concentrate on cases where their professional experience and judgment is needed most.

The system and method comprises three stages, including identity verification, detection and investigation. The first stage of identity verification is an automated batch process for providing automated data gathering and decision processes carried out with the goal of resolving as many cases as possible without human intervention. In a document-oriented application, the classification stage begins with the arrival of an input document represented by a dataset. In the detection stage, human judgment may be employed to resolve ambiguities, obtain additional data, and arbitrate borderline classification decisions. The goal is to classify the cases that the previous stage was unable to resolve and to select the high-risk cases to forward to the third stage for a more thorough and time-consuming investigation by highly skilled investigators.

The present invention is enterprise software that provides a configurable, plug-and-play solution that will search, analyze, and operate on transactional and historical data in real-time across remote and disparate databases. The software has the unique ability to discover similarities and non-obvious relationships in data in real-time and apply the results of data analysis to an operational environment. It has a flexible framework for building a variety of applications that can be configured based on application requirements. Using an open API, the framework enables organizations to easily incorporate multiple technologies, analytics, software components, and both internal and external data sources. The system performs tasks such as decision automation, transaction processing, and extraction of knowledge from data sources. It can provide the following capabilities: search, analyze, and operate on both transactional and historical data in remote, disparate databases; uncover non-obvious relationships; find similarities as well as exact matches; apply analytical results in an operational environment; easily interoperate with other enterprise applications; combine the results from several different analytics to produce one comprehensive score; search and process large amounts of data in real-time; protect data ownership by using remote search; ensure technology investment due to the ability to easily update and expand the system; operate in serial and parallel environments; protect privacy by returning scores instead of actual data; operate on data with different data types, platforms, and formats; produce a complete audit trail for all search and analytical results; and quickly and easily incorporates multiple analytics, software components, and internal and external data sources. The invention enables more accurate and informed decisions; streamlines operational processes; increases efficiencies and reduces operational costs; transforms data in real-time into useful and useable information; improves customer service and customer interaction; and drives more profitable relationships with customers. It may be used in business-critical applications including employee background checks, risk assessment, fraud detection, data mining, alias identification, market analysis, and customer identification. Modular software components provide unique analytical capabilities such as link analysis, fuzzy search, similarity scoring and classifications, and rules processing as well as a complete decision audit trail. The invention also accepts and integrates third party analytics and software components.

An embodiment of the present invention is a method for identification, detection and investigation of maleficent acts, comprising the steps of receiving one or more transaction datasets, verifying each transaction dataset identity and classifying each transaction dataset into a first category, a second category and a third category, detecting and arbitrating ambiguities in each transaction dataset in the second category for reclassifying into the first category and the third category, investigating each transaction dataset in the third category for affirming the third category classification of a first group of investigated datasets and reclassifying the third category classification of a remaining second group of investigated datasets into the first category classification, enabling transaction datasets in the first category, and disabling transaction datasets in the third category. The step of receiving one or more transaction datasets may further comprise receiving one or more transaction datasets selected from the group consisting of airline reservations, cargo transactions, border crossings, Patriot Act transactions, insurance claims, underwriting insurance transactions, and credit applications. The step of verifying and classifying may further comprise verifying each transaction dataset identity by assigning a composite score to each transaction dataset and classifying each transaction dataset by assigning each dataset to the predetermined categories according to each dataset composite score. The composite score assigned to each transaction dataset may be determined by combining one or more analytical scores based on a comparison between each transaction dataset and one or more similar datasets located in disparate databases. The means for determining the one or more analytical scores may be selected from the group consisting of a similarity search engine, a biometric analytic, a rules engine, and a neural net. The method may further comprise the step of assigning a composite score to each transaction dataset according to a schema defined by a user. The method may further comprise designating an analytic function in the schema selected from the group consisting of a similarity search function, a biometric function, a rules function, and a neural net function. The step of classifying datasets into categories may be determined by preset classes, business rules and associations determined by a user to meet specific business needs. The method may further comprise the step of controlling and monitoring a workflow process comprising the steps of receiving, verifying and classifying, detecting and arbitrating, investigating, enabling and disabling. The step of detecting and arbitrating ambiguities may comprise the steps of receiving transaction datasets classified into the second category in the verifying step, enabling an arbitrator to view a summary list screen showing transaction dataset identification, classification, status, justification, and links to a transaction dataset detail screen, a search form screen, and a search queue screen, enabling the arbitrator to view a task detail screen for comparing analytical scores between selected transaction datasets and datasets contained in disparate databases, and enabling the arbitrator to change the classification of transaction datasets from the second category into a category selected from the group consisting of the first category and the third category. The method may further comprise enabling the arbitrator to select an analytic function for determining a comparative analytical score of a selected transaction dataset, the analytic function selected from the group consisting of a similarity search function, a biometric function, a rules function, a neural net function, a model engine and a decision tree. The method may further comprise enabling the arbitrator to update a classification and status of selected transaction datasets. The step of investigating each transaction dataset in the third category may comprise the steps of receiving transaction datasets classified into the third category in the steps of verifying and detecting, enabling an investigator to view a summary list screen showing transaction datasets containing links to a task detail screen, a search form screen, and a search queue screen, enabling the investigator to view a task detail screen for comparing elements of a selected transaction dataset to elements from comparison datasets contained in disparate databases, and enabling the investigator to change the classification of transaction datasets from the second category into the first category and the third category. The method may further comprise enabling the investigator to select an analytic function for determining a comparative analytical score of a selected transaction dataset, the analytic function selected from the group consisting of a similarity search function, a biometric function, a rules engine, a neural net, a model engine, an auto link analysis, a decision tree, and a report engine. The method may further comprise activating remote similarity search agents in disparate databases to be searched by a similarity search function, the remote similarity search agents returning similarity scores and results to the similarity search function without a requirement for relocating the searched information from the disparate databases. An embodiment is a computer-readable medium containing instructions for controlling a computer system according to the method described above.

Another embodiment is a system for identification, detection and investigation of maleficent acts, comprising a means for receiving one or more transaction datasets, a means for verifying each transaction dataset identity and classifying each transaction dataset into a first category, a second category and a third category, a means for detecting and arbitrating ambiguities in each transaction dataset in the second category for reclassifying into the first category and the third category, a means for investigating each transaction dataset in the third category for affirming the third category classification of a first group of investigated datasets and reclassifying the third category classification of a remaining second group of investigated datasets into the first category classification, a means for enabling transaction datasets in the first category, and a means for disabling transaction datasets in the third category. The means for receiving and the means for verifying and classifying may comprise a classification engine, the means for detecting and arbitrating may comprise an arbitration function, and the means for investigating may comprise an investigation function. The system may further comprise a workflow manager for controlling and monitoring a workflow process comprising the means for of receiving, verifying and classifying, detecting and arbitrating, investigating, enabling and disabling. The classification engine, the arbitration function and the investigation function may have access to disparate databases through analytic functions. The system disparate databases may comprise an alias identification database, an expert rules database, a government threat database, public databases, and known threat databases. The disparate databases may contain remote similarity search agents for returning similarity scores and results to the similarity search engine without a requirement for relocating the searched information from the disparate databases. The analytic functions may comprise a similarity search function, a biometric function, a rules engine, a neural net, a model engine, an auto link analysis, a decision tree, and a report engine. The arbitration function may include a user interface for enabling a user to arbitrate the second category classification decisions made by the classification engine into the first and third category classification. The investigation function may include a user interface for enabling a user to investigate the third category classification decisions made by the classification engine and the arbitration function and to reassign them to the first and the third category classification.

Yet another embodiment of the present invention is a method for identification, detection and investigation of maleficent acts, comprising the steps of controlling a workflow process for classifying transaction datasets into a high risk category and a low risk category, including the steps of verifying and classifying transaction datasets, detecting and arbitrating transaction dataset ambiguities, investigating high risk transaction datasets for ensuring correct classification, initiating analytic functions comprising a similarity search function, a biometric function, a rules engine, a neural net, a model engine, an auto link analysis, a decision tree, and a report engine, and accessing disparate databases including an alias identification database, an expert rules database, a government threat database, public databases, and known threat databases. The disparate databases may contain remote similarity search agents for returning similarity scores and results to the similarity search engine without a requirement for relocating the searched information from the disparate databases.

### BRIEF DESCRIPTION OF THE DRAWINGS

These and other features, aspects and advantages of the present invention will become better understood with regard to the following description, appended claims, and accompanying drawings wherein:

FIG. 1 shows overlapping multiple reasoning methodologies according to the present invention;

FIG. 2 shows a functional flow diagram depicting the process according to the present invention;

FIG. 3 shows a system block diagram depicting the technology for supporting the present invention;

FIG. 4 shows system configuration of an embodiment of the present invention;

FIG. 5A shows a process used historically for airline security activities;

FIG. 5B shows a process according to the present invention for airline security activities;

FIG. 6A shows a process used historically for insurance claim processing for fraud detection;

FIG. 6B shows a process according to the present invention for insurance claim processing for fraud detection;

FIG. 7 shows a screenshot summarizing the detection arbitration step;

FIG. 8 shows a screen shot that provides a user with a summary view of a result from a specific identity verification and classification; and

FIG. 9 shows a screen shot of a link analysis tool used in the investigative step.

### DETAILED DESCRIPTION OF THE DRAWINGS

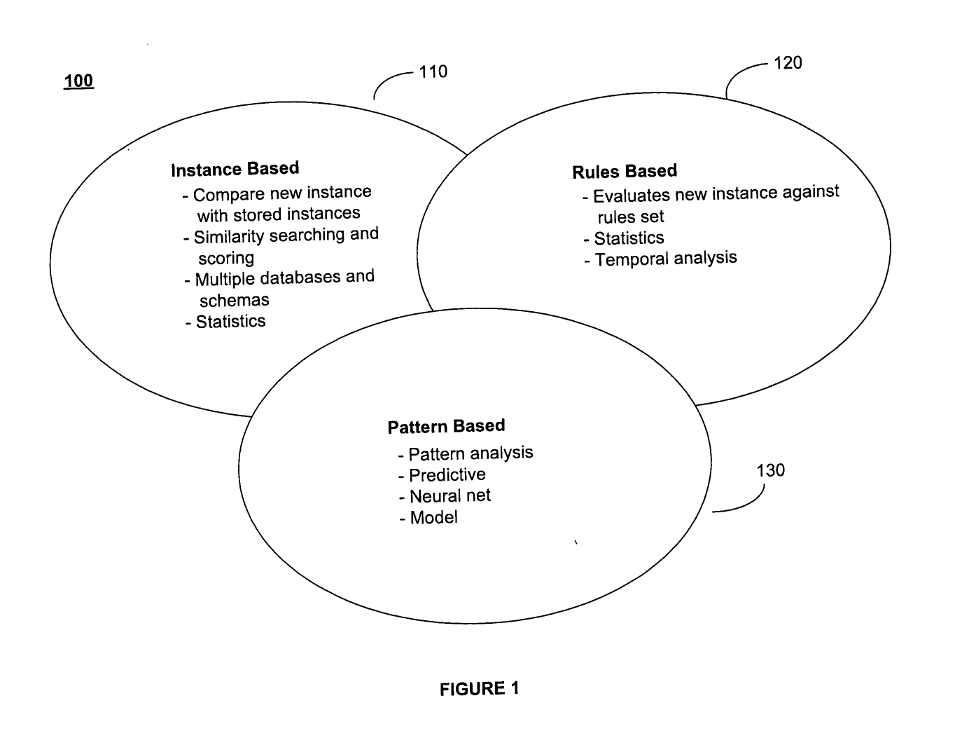

Turning now to FIG. 1, FIG. 1 shows overlapping multiple reasoning methodologies 100 according to the present invention. No single reasoning model can detect all possible maleficent activities, and no reasoning model is inherently more superior to other models. Since each reasoning model is able to provide unique characteristics of maleficent acts, an ideal system for identification, detection an investigation of maleficent acts would be multimodal with capability for detecting threats along each of three dimensions, which include instance base 110, rules based 120 and pattern based 130 detection capabilities. The overlapping methodologies shown in FIG. 1 illustrate the fact that each methodology incorporates some of the capabilities of other methodologies. For example, with instance based reasoning 110, rules may be embedded as hypothetical instances in a database, such as the case of embedding an example bad record in a database of the purchase of a one-way ticket within 30 minutes prior to an aircraft departure. Pattern instances embedded within data may also be identified. For more complex rules and pattern applications, other methodologies must be incorporated into a solution. The present invention provides a framework and tools necessary to support three reasoning methodologies for identification, detection and investigation of maleficent activities, including instance base reasoning 110, rules based reasoning 120 and pattern based reasoning 130. It uses a “federation” based architecture for ease of adding new databases, new reasoning engines work flow components, etc. through well documented APIs and interfaces that make use of XML and synchronous message queues.

Rule based reasoning 120 provides an ability to set rules and detect violation of rules. For example, in a given situation, only a given set of actions may be appropriate. These systems are generally equipped with a rules-based reasoning engine, and are trained through a period of testing and qualification of the rules base.

Pattern based reasoning 130 provide the ability to detect explicit and implicit patterns involving inputs that may predict maleficent activities. Explicit pattern based systems are characterized by model-based reasoning and probabilistic reasoning systems such as Bayesian networks. Implicit pattern-based systems typically fall into the domain of neural networks that are capable of discovering predictability patterns that a human might not be able to perceive. These systems require extensive training through introduction of numerous previously classified results and input patterns, and are generally not strong at detecting instance-based threats. Since it may take a significant period of time for training such a system, retraining is conducted on a continuous basis, and it may not respond fast enough in some critical instances, such as changes in a “watch” list. These systems generally do not provide a user with justification for a classification result.

Instance based reasoning 110 provides an ability to detect attribute values that have been seen previously, either in known good or known bad situations. For example, a travel reservation may contain a name, address or telephone number that is the same or similar to a known good or known ad person who is listed in a database. Data instances used for classification are not necessarily directly associated with the primary transaction, because instance based systems employ schematic and semantic mapping tools that enable searching of disparate data sources. For example, a transaction involving an airline reservation may be compared to names, addresses, telephone numbers, etc. in several known person databases. These systems are immediately trained when new instance information is inserted into any of the targeted databases. Classifications performed by an instance based reasoning engine are “non-profiling”, and have been used successfully to prosecute individuals and well as groups of individuals.

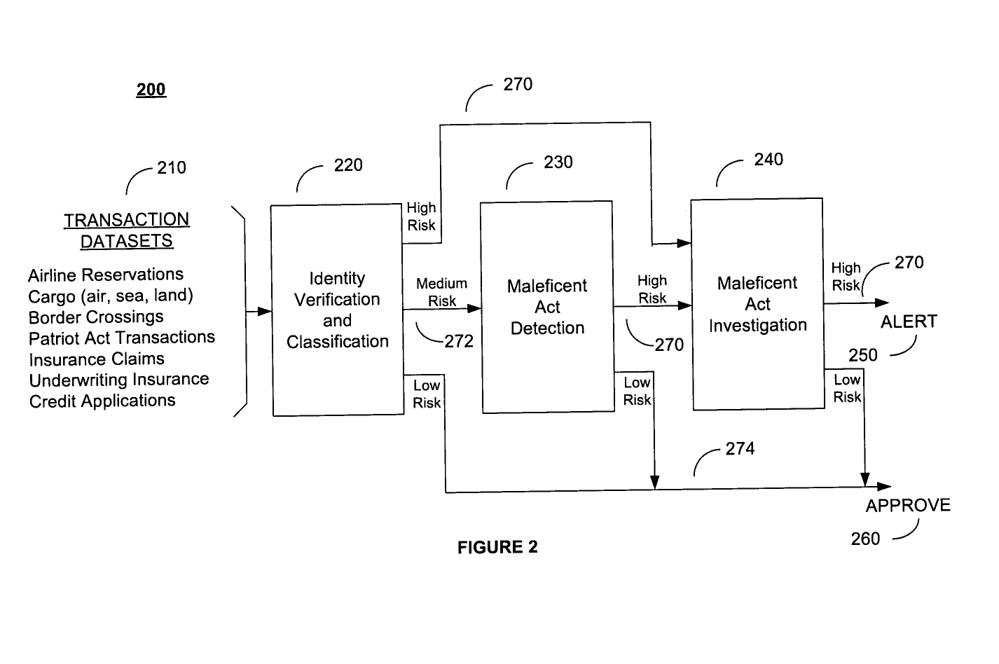

Turning to FIG. 2, FIG. 2 shows a functional flow diagram depicting the process 200 according to the present invention. The process 200 comprises three stages: identity verification and classification 220, maleficent act detection 230 and maleficent act investigation 240. Multiple procedures may be involved in each stage and the automated classification technologies may vary with the application. The process starts with an automated classification process 220 where identifying information is extracted from input documents or transaction datasets 210 and used to search databases containing the records of individuals. Identity data can consist of biometric data and/or standard identification such as name, address, phone number, etc. This data can then be matched against a variety of databases, such as biometric, public records, etc., to confirm whether the identity exists and if the person is, in fact, who he/she claims to be. In addition, identification analytics can be employed to look for inconsistent representations of identity where, for example, a person claims to be 42 years old when the identification data indicates the age of 10 years old. Analytics may also detect fraudulently manufactured identification, for example, a created false identification or assumption of another person's identification. Such identifications may be rare, but they are immediate and authoritative, and provide the earliest warning of the potential maleficent activities. In the identity verification and classification stage 220, transaction datasets 210 are received by this stage from various sources. The transaction datasets 210 may be airline reservations, way bills for cargo, border crossings, Patriot Act transactions, insurance claims, underwriting insurance documents, credit applications, etc. The identity verification and classification stage 220 classifies individuals identified in the transaction datasets, sending datasets associated with high risk individuals 270 to the investigation stage 240, and sending datasets associated with medium risk individuals 272 to the detection stage 230, and categorizing as approved 260 those datasets associated with low risk individuals 274.

The second stage 230 of the process 200 enables an organization to quickly sort out the high and low risk individuals from the medium risk individuals determined by the first stage 220 by sending datasets associated with the high risk individuals 270 to the investigation stage 240 and categorizing as approved 260 those datasets associated with low risk individuals 274. The process facilitates a workflow according to level of risk. High-risk individuals 270 may be work-flowed directly to the investigation stage 240. Medium risk individuals 272 can be work-flowed to the detection stage 230 in order to apply the additional human insight and judgment needed to resolve them. Low risk individuals 274 can be cleared immediately as approved. At the same time, external analytics can examine an individual's history and demographics for indicators of maleficent activities, returning scores that enable another percentage of the inputs to be classified for approval or further examination. The result is that all cases that can be resolved without human intervention are completed in the automated identity verification stage 220. The detection stage 230 brings human judgment and additional data resources into the process in order to resolve another percentage of the cases. However, the knowledge and experience of the personnel involved in this stage do not need to be on a par with those involved in the investigation stage 240. Their function in the detection stage 230 is to review the data for unresolved cases and to determine which can be approved immediately, which need to go on the investigation stage 240, and which need additional data. A web-based tool provides the arbitrators involved in the detection stage 230 with data used in the classification stage 220, the rationale for the classification, and access to additional data that may be needed to make a clear identification or classification. Information such as references to stolen credit cards and/or similarity matches with known threats are provided for a more in-depth analysis as to the nature of the threat or fraud. Additional information and external databases may be accessed to perform this task.

In the investigation stage 240, cases datasets that have been found to have the highest probability of maleficent activities are work-flowed to specialists for further investigation. These specialists are equipped with strong tools for similarity searching, link charting, time lining, pattern matching, and other investigative techniques. The first two stages of the process 200 guarantee that when a case dataset reaches the investigative stage 240, the data involved in the classification has been gathered and reviewed, and every effort has been made to resolve it based on all information available. This allows investigators to make the best use of their time by applying their valuable skills and resources to the cases that are most critical. Once cases are resolved as high risk 270 or low risk 274, discoveries made during the investigation stage 240 can be used to update a knowledge base in order to provide for continuous improvement in the detection stage 230 and investigation stage 240. The high risk case datasets 270 are placed in an alert category, to be acted upon by appropriate personnel.

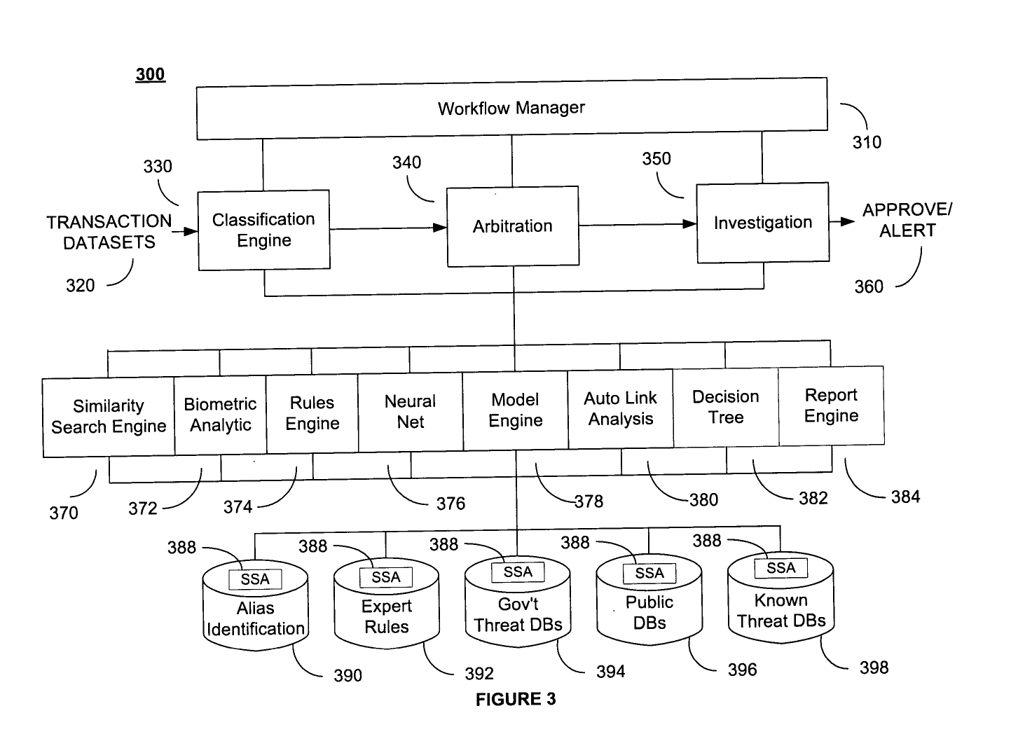

FIG. 3 shows a system block diagram 300 depicting the technology for supporting the present invention. The overall workflow process is controlled by a workflow manager 310 that is disclosed in U.S. patent application Ser. No. 10/653,457, filed on Sep. 2, 2003, and incorporated herein by reference. It controls the sequencing of activities between a classification engine 330 for identity verification and classification, a arbitration function 340 and an investigative function 350, as transaction datasets 320 progress through the system 300. The classification engine 330 is disclosed in U.S. patent application Ser. No. 10/653,432, filed on Sep. 2, 2003, and incorporated herein by reference. The arbitration function 340 is disclosed in U.S. patent application Ser. No. 10/653,689, filed on Sep. 2, 2003, and incorporated herein by reference. The similarity search engine 370 is disclosed in U.S. patent application Ser. No. 10/653,690, filed on Sep. 2, 2003, and incorporated herein by reference. Although each provide a separate function, the classification engine 330, the arbitration function 340 and the investigation function 350 all are able to access multiple analytics, including similarity search engines 370, biometric analytics 372, rules engines 274, neural nets 376, model engines 378, auto link analysis 380, decision tree analysis and report engines 384. These analytic function provide access to numerous disparate databases, including alias identification databases 390, expert rule databases 392, government threat databases 394, public databases 396, and known threat databases 398. Remote similarity search agents 388 are located in each database to facilitate similarity searching. The classification engine 330 automatically gathers transaction datasets 320 and processes decisions to resolve as many cases as possible without human intervention. It provides an ability to access multiple data sources in real-time and in batch mode, as well as multiple data target databases, while meeting strict security and privacy requirements. It is able to incorporate multiple analytics into a single scoring and classification model, as well as to configure and modify the workflow of the various analytics and target datasets located in databases in order to deploy multiple assessment methodologies. The classification engine 330 has an ability to verify identity, score risk and classify the results employing multiple analytics and multiple target datasets in near real-time, and to notify or alert the relevant authorities on high risk individuals and provide an audit trail or justification of results. It provides an ability to adjust threat tolerance levels, to analyze risk on a higher level and relative to historical patterns for providing trends and patterns, and to maintain relevant data for intelligence purposes. The arbitration function 340, human judgment is employed to resolve ambiguities, obtain additional data, and arbitrate borderline classification decisions. The goal of the arbitration function 340 is to classify the cases that the classification engine 330 was unable to resolve and to select the high-risk cases to forward to the investigation function 350 for further investigation. In the investigation function 350, trained investigators pursue high-risk individuals identified in the previous stages. Most of their cases come from referrals from the arbitration function 340, but may also arrive directly from the classification engine 330.

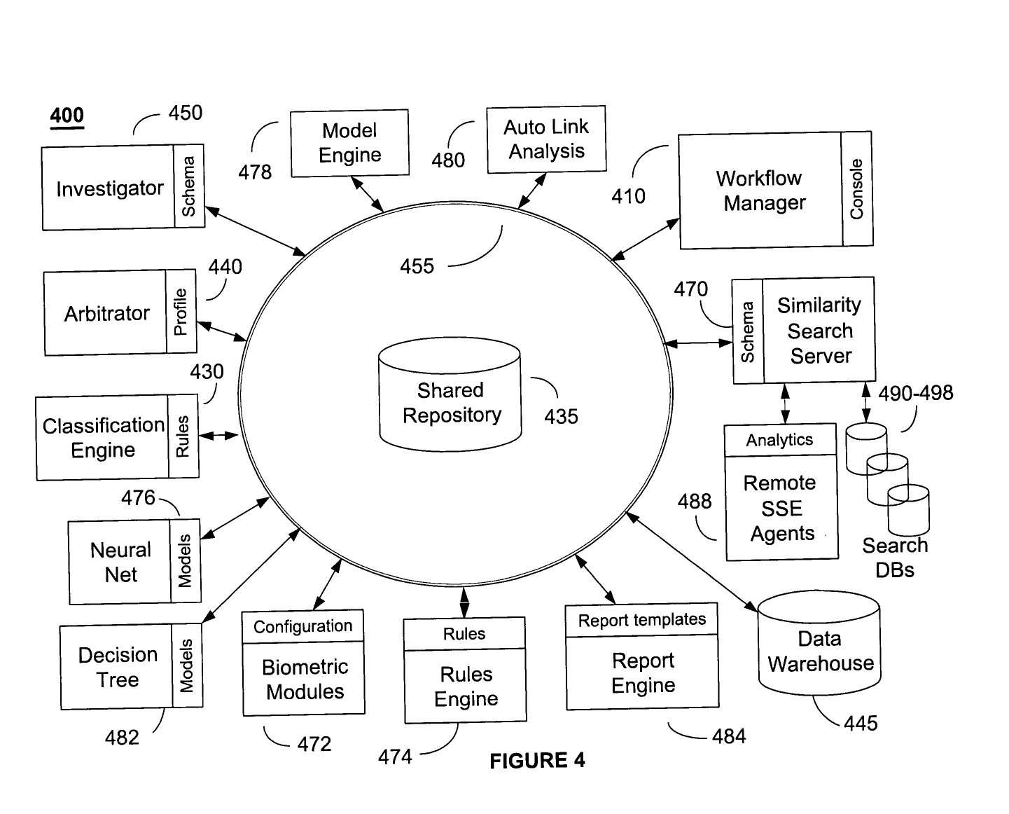

Turning to FIG. 4, FIG. 4 shows system configuration of an embodiment of the present invention connected in a flexible services network configuration 400. Performance and scalability is achieved by using a flexible, dynamic services network 400, also referred to as a “Federation”, as depicted in FIG. 4. A workflow manager 410 is connected to the network and invokes services needed via the network. In this configuration 400, instead of calling an explicit computer or node, the workflow manager 410 makes a request to application nodes such as an investigator 450, an arbitrator 440 or a classification engine 430 using a queue 455 and other resources in the network 400. The request is routed to available application nodes 430, 440, 450, which performs the request and returns the result back to the workflow manager 410. The workflow manager 410 defines and uses the applications nodes 430, 440, 450 as virtual services, and a network controller determines actual available services dynamically. The workflow manager 410 shares a common repository 435 with the application nodes 430, 440, 450 and various analytic functions, including a similarity search server 470, biometric modules 472, rules engine 474, neural network 476, model engine 478, auto link analysis 480, decision tree 482, and report engine 484. A data warehouse 445 also provides a data source for use by the system. The similarity search server 470 uses remote search agents 488 to access and search remote databases 490-498. The flexible services network 400 may easily accommodate various user applications through use of standard APIs. The workflow manager 410 controls the overall workflow process. The workflow manager 410 controls a transaction dataset through the process model, keeping track of progress along the way. The workflow manager 410 functions as a command server. It accepts various workflow commands to invoke workflow processes and to return the status of current workflow processes. In the services network architecture 400, the workflow manager 410 is a workflow service node, communicating to other components through the network “Federation”. Several other workflow utility applications are included in the workflow manager 410 for various utilitarian functions. Utilities include workflow scheduling, data cleanup, data importing and exporting, batch processing, and various process and data management tools. Another utility is a workflow monitor that monitors specific events, actions, or data from a node, indicating completion or status. Workflow user applications may be connected to the network 400 to make use of workflow results. The workflow manager 410 is controlled by a user-defined task definition, which presents a list of transaction datasets for the system to process. The workflow manager 410 creates and manages these tasks per process model definitions. The workflow manager 410 also enables users to interface with workflow artifacts via the arbitrator 440 and investigator 450.

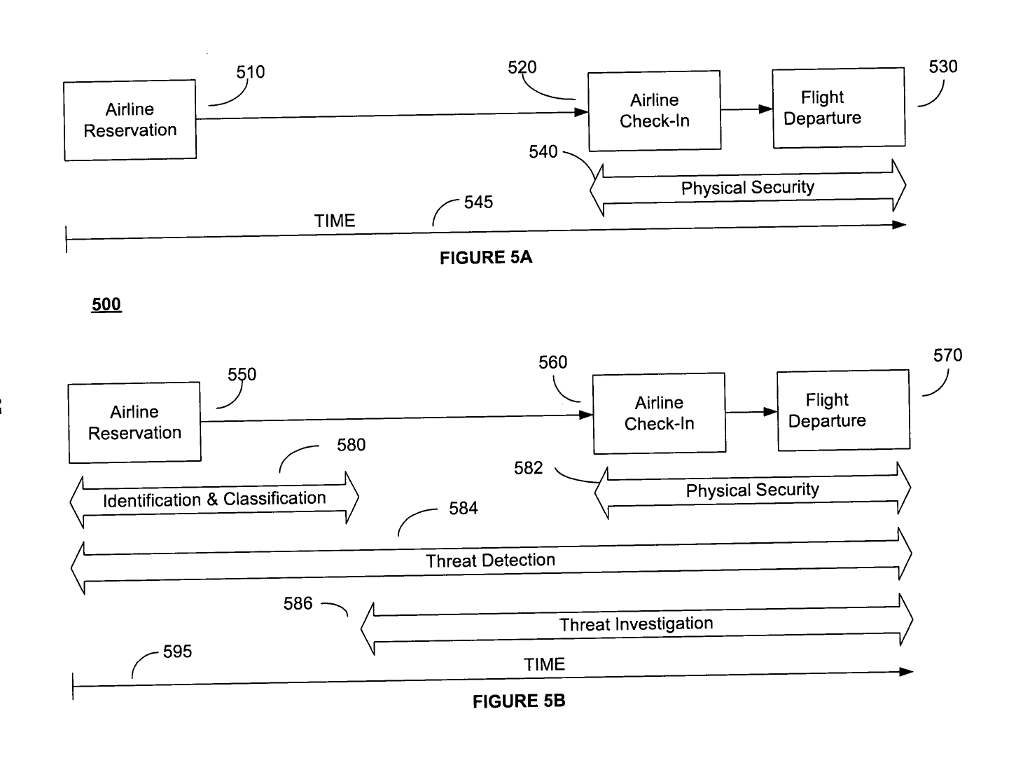

Turning to FIG. 5, FIG. 5A shows a process used historically for airline security activities according to a timeline 545. After an airline reservation 510 was made, there were no further checks made to ascertain security threats until physical security 540 was conducted when an individual checked in 520 at an airline counter and a flight departed the airport 530. FIG. 5B shows a process according to the present invention for airline security activities according to a timeline 595. Threat detection 585 is initiated when an airline reservation 550 is made and processed through time of airline check-in 560 and flight departure 570. When an airline reservation is made 550, a transaction dataset representing passenger information is processed through a step of identification and classification 580. After this initial automated screening step 580, threat investigation 586 is initiated to screen datasets indicative of high threat risk, as determined by the step of identification and classification 580 and the step of threat detection 584. Physical security 582 is also carried out to further screen potential threats and to prevent high risk individuals from boarding an aircraft.

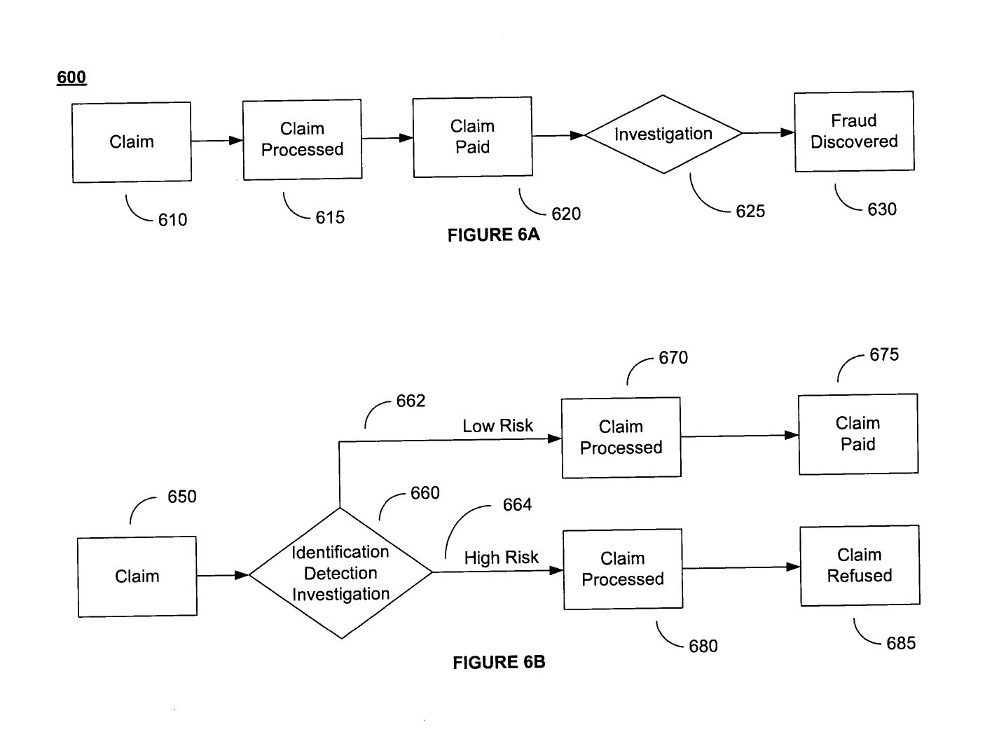

Turning to FIG. 6, FIG. 6A shows a process used historically for insurance claim processing for fraud detection. When a claim is made to an insurance company 610, it is processed 615 and the claim is paid 620. Only after a claim has been paid 620 is an investigation conducted 625 to discover if there has been any fraudulent activity 630. At this point, it may be impossible to recover any claim fees paid. FIG. 6B shows a process according to the present invention for insurance claim processing for fraud detection. When a claim is made to an insurance company 650, it is processed according to the present invention through the steps of identification, detection and investigation 660. Claims determined to be low risk 662 are processed 670 and paid 675. Claims determined to be high risk 664 are further processed 680 and refused 685.

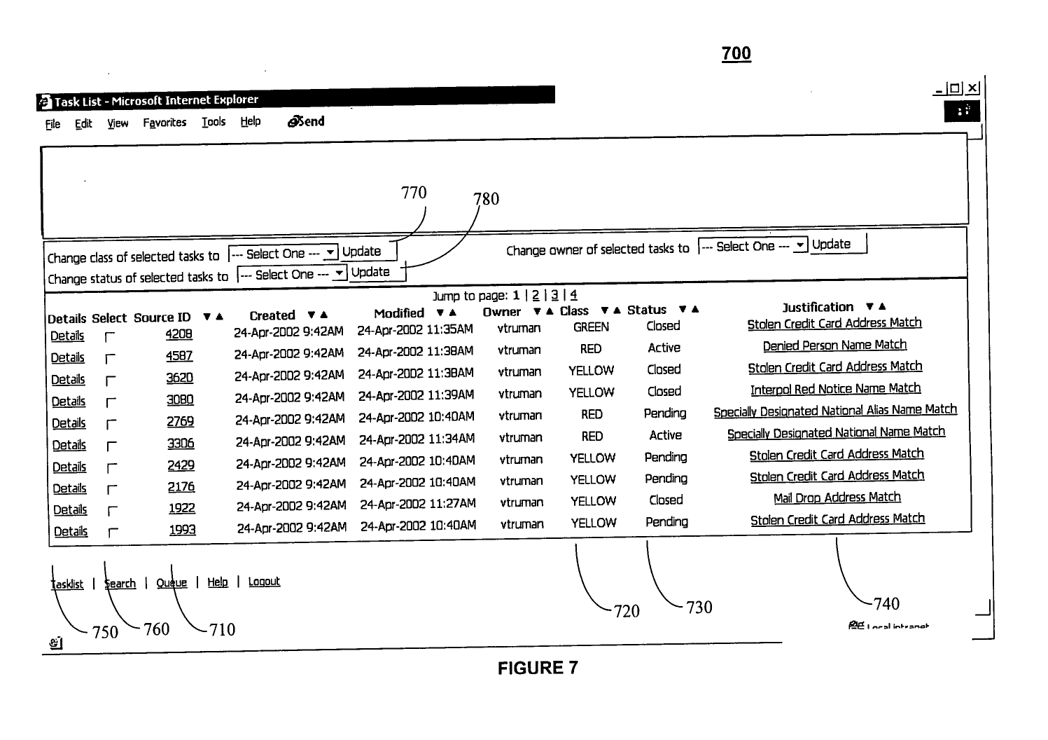

Turning to FIG. 7, FIG. 7 shows a screenshot 700 summarizing the detection arbitration step. FIG. 7 depicts a partial list of transaction datasets being arbitrated in the detection stage of the present invention. The screenshot 700 lists an identification 710 of each transaction dataset displayed. A classification status 720 is indicated as red, yellow and green, indicative of high risk, medium risk and low risk. The current status 730 of each transaction dataset if indicated, in addition to a justification 740 for each classification. If a user desires more detail, a “Details” hyperlink 750 may be selected to display dataset details. Selecting a check box 760 and clicking on a change class update 770 may change a dataset classification 720. Selecting a check box 760 and clicking on a change status update 780 may change a dataset status 730.

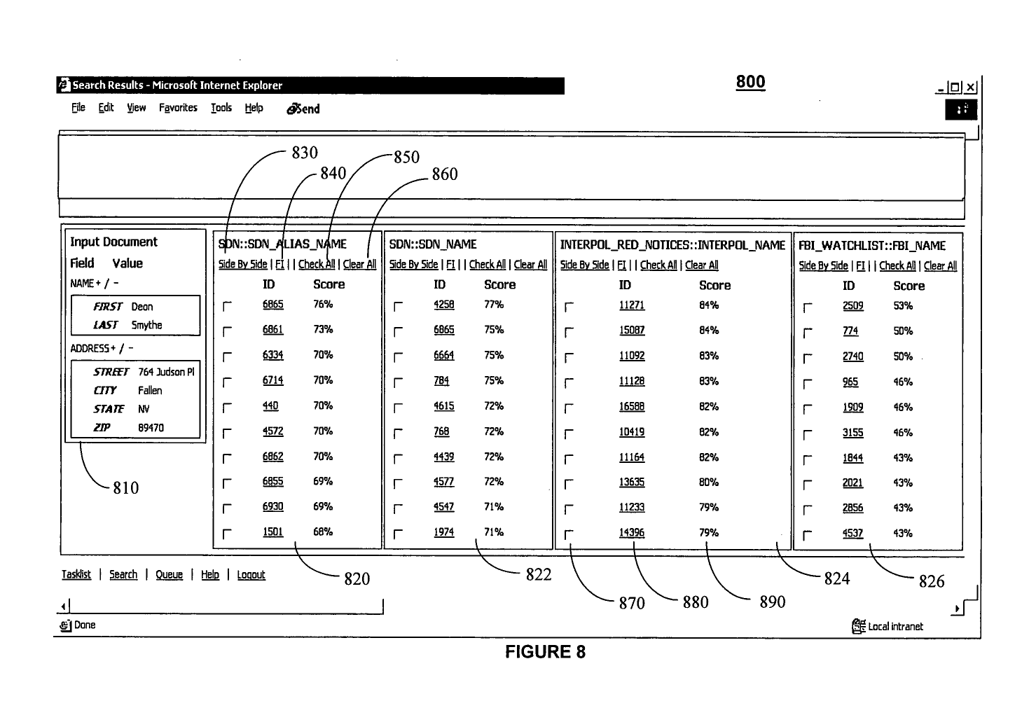

Turning to FIG. 8, FIG. 8 shows a screen shot 800 that provides a user with a summary view of a result from a specific identity verification and classification. The screenshot 800 displays five main sections, an original criteria for the search 810 and a summary table of search results 820, 822, 824 826 from each query that was executed by an arbitrator. The query document section 810 displays the field name, and criteria value for each populated field in the original query document. Unpopulated fields may be hidden. The results for each query are displayed in a separate summary table section 820, 822, 824, 826 having a header label indicating the target schema and mapping used to generate the query. Each table section 820, 822, 824, 826 displays the following links in it's header: “Side by Side” 830 opens the selected documents in a side-by-side view with the translated criteria used to generate that result set; “FI” 840 opens an entire result set in the investigative analysis application; “Check All” 850 selects all documents in the result set; and “Clear All” 860 deselects all documents in the result set. The table sections of search results 820, 822, 824, 826 display a row for each returned document in the result set. Each row displays the following items in columnar fashion: a checkbox 870 to select the given document, the document Identification 880 linked to the document detail view for this document, and the document's score 890. The summary table sections of search results 820, 822, 824, 826 are not paginated. The user is able to select one or more documents from the results table sections and navigate to a side-by-side view by pressing the “Side-by-Side” button 830 next to selected documents.

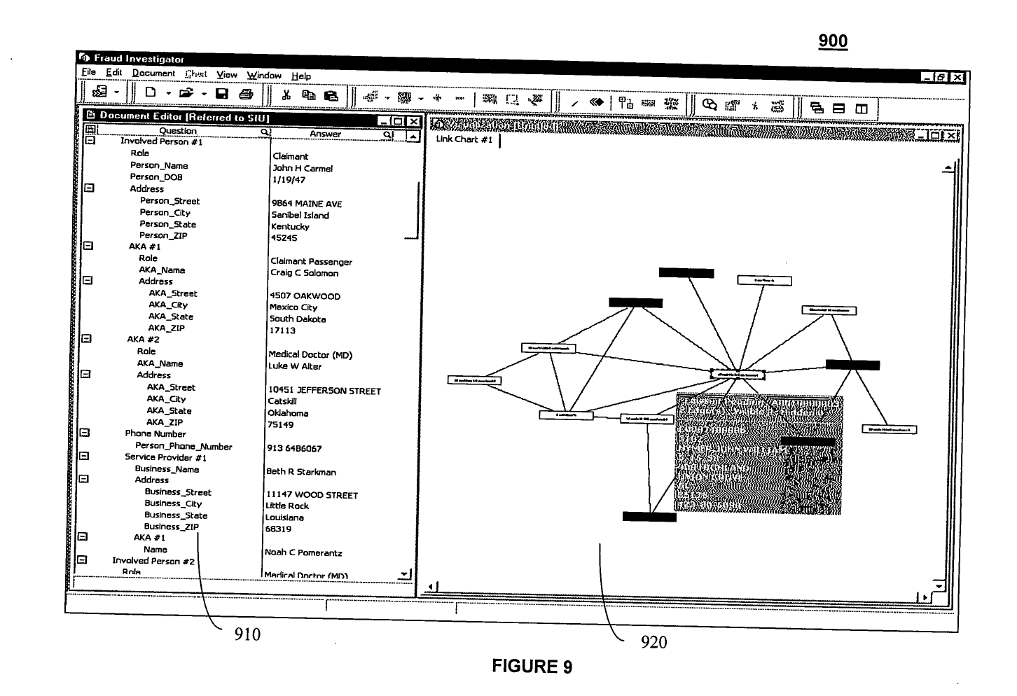

Turning to FIG. 9, FIG. 9 shows a screen shot 900 of a link analysis tool used in the investigative step of the present invention. Based on a similar or partial match between an individual associated with a transaction dataset and a database of known threats found in earlier identification and detection stages, an investigator may perform additional background searches by simply clicking the relevant databases to further refine a potential threat. If further investigation is warranted, the link analysis tool 900 may access the results from the classification or detection process. The link analysis tool 900 may illustrate an identification section 910 for identifying an individual and an additional list of possible associations related to the individual. A second graphic section 920 provides a graphical depiction of the individual with links to other related information. This link-chart methodology is one of several investigatory methods for uncovering suspicious associations that an investigator might use.

Although the present invention has been described in detail with reference to certain preferred embodiments, it should be apparent that modifications and adaptations to those embodiments might occur to persons skilled in the art without departing from the spirit and scope of the present invention.

1. A method for identification, detection and investigation of maleficent acts, comprising the steps of:
receiving one or more transaction datasets;
verifying each transaction dataset identity and classifying each transaction dataset into a first category, a second category and a third category;
detecting and arbitrating ambiguities in each transaction dataset in the second category for reclassifying into the first category and the third category;
investigating each transaction dataset in the third category for affirming the third category classification of a first group of investigated datasets and reclassifying the third category classification of a remaining second group of investigated datasets into the first category classification;
enabling transaction datasets in the first category; and
disabling transaction datasets in the third category.

2. The method of claim 1, wherein the step of receiving one or more transaction datasets further comprises receiving one or more transaction datasets selected from the group consisting of airline reservations, cargo transactions, border crossings, Patriot Act transactions, insurance claims, underwriting insurance transactions, and credit applications.

3. The method of claim 1, wherein the step of verifying and classifying further comprises verifying each transaction dataset identity by assigning a composite score to each transaction dataset and classifying each transaction dataset by assigning each dataset to the predetermined categories according to each dataset composite score.

4. The method of claim 3, wherein the composite score assigned to each transaction dataset is determined by combining one or more analytical scores based on a comparison between each transaction dataset and one or more similar datasets located in disparate databases.

5. The method of claim 4, wherein a means for determining the one or more analytical scores is selected from the group consisting of a similarity search engine, a biometric analytic, a rules engine, and a neural net.

6. The method of claim 3, further comprising the step of assigning a composite score to each transaction dataset according to a schema defined by a user.

7. The method of claim 6, further comprising designating an analytic function in the schema selected from the group consisting of a similarity search function, a biometric function, a rules function, and a neural net function.

8. The method of claim 1, wherein the step of classifying datasets into categories is determined by preset classes, business rules and associations determined by a user to meet specific business needs.

9. The method of claim 1, further comprising the step of controlling and monitoring a workflow process comprising the steps of receiving, verifying and classifying, detecting and arbitrating, investigating, enabling and disabling.

10. The method of claim 1, wherein the step of detecting and arbitrating ambiguities comprises the steps of:
receiving transaction datasets classified into the second category in the verifying step;
enabling an arbitrator to view a summary list screen showing transaction dataset identification, classification, status, justification, and links to a transaction dataset detail screen, a search form screen, and a search queue screen;
enabling the arbitrator to view a task detail screen for comparing analytical scores between selected transaction datasets and datasets contained in disparate databases; and
enabling the arbitrator to change the classification of transaction datasets from the second category into a category selected from the group consisting of the first category and the third category.

11. The method of claim 10, further comprising enabling the arbitrator to select an analytic function for determining a comparative analytical score of a selected transaction dataset, the analytic function selected from the group consisting of a similarity search function, a biometric function, a rules function, a neural net function, a model engine and a decision tree.

12. The method of claim 10, further comprising enabling the arbitrator to update a classification and status of selected transaction datasets.

13. The method of claim 1, wherein the step of investigating each transaction dataset in the third category comprises the steps of:
receiving transaction datasets classified into the third category in the steps of verifying and detecting;
enabling an investigator to view a summary list screen showing transaction datasets containing links to a task detail screen, a search form screen, and a search queue screen;
enabling the investigator to view a task detail screen for comparing elements of a selected transaction dataset to elements from comparison datasets contained in disparate databases; and
enabling the investigator to change the classification of transaction datasets from the second category into the first category and the third category.

14. The method of claim 13, further comprising enabling the investigator to select an analytic function for determining a comparative analytical score of a selected transaction dataset, the analytic function selected from the group consisting of a similarity search function, a biometric function, a rules engine, a neural net, a model engine, an auto link analysis, a decision tree, and a report engine.

15. The method of claim 1, further comprising activating remote similarity search agents in disparate databases to be searched by a similarity search function, the remote similarity search agents returning similarity scores and results to the similarity search function without a requirement for relocating the searched information from the disparate databases.

16. A computer-readable medium containing instructions for controlling a computer system according to the method of claim 1.

17. A system for identification, detection and investigation of maleficent acts, comprising:
a means for receiving one or more transaction datasets;
a means for verifying each transaction dataset identity and classifying each transaction dataset into a first category, a second category and a third category;
a means for detecting and arbitrating ambiguities in each transaction dataset in the second category for reclassifying into the first category and the third category;
a means for investigating each transaction dataset in the third category for affirming the third category classification of a first group of investigated datasets and reclassifying the third category classification of a remaining second group of investigated datasets into the first category classification;
a means for enabling transaction datasets in the first category; and
a means for disabling transaction datasets in the third category.

18. The system of claim 17, wherein:
the means for receiving and the means for verifying and classifying comprise a classification engine;
the means for detecting and arbitrating comprise an arbitration function; and
the means for investigating comprise an investigation function.

19. The system of claim 17, further comprising a workflow manager for controlling and monitoring a workflow process comprising the means for of receiving, verifying and classifying, detecting and arbitrating, investigating, enabling and disabling.

20. The system of claim 18, wherein the classification engine, the arbitration function and the investigation function have access to disparate databases through analytic functions.

21. The system of claim 20, wherein the disparate databases comprise an alias identification database, an expert rules database, a government threat database, public databases, and known threat databases.

22. The system of claim 21, wherein the disparate databases contain remote similarity search agents for returning similarity scores and results to the similarity search engine without a requirement for relocating the searched information from the disparate databases.

23. The system of claim 21, wherein the analytic functions comprise a similarity search function, a biometric function, a rules engine, a neural net, a model engine, an auto link analysis, a decision tree, and a report engine.

24. The system of claim 19, wherein the arbitration function includes a user interface for enabling a user to arbitrate the second category classification decisions made by the classification engine into the first and third category classification.

25. The system of claim 19, wherein the investigation function includes a user interface for enabling a user to investigate the third category classification decisions made by the classification engine and the arbitration function and to reassign them to the first and the third category classification.

26. A method for identification, detection and investigation of maleficent acts, comprising the steps of:
controlling a workflow process for classifying transaction datasets into a high risk category and a low risk category, including the steps of:
verifying and classifying transaction datasets;
detecting and arbitrating transaction dataset ambiguities;
investigating high risk transaction datasets for ensuring correct classification;
initiating analytic functions comprising a similarity search function, a biometric function, a rules engine, a neural net, a model engine, an auto link analysis, a decision tree, and a report engine; and
accessing disparate databases including an alias identification database, an expert rules database, a government threat database, public databases, and known threat databases.

27. The method of claim 26, wherein the disparate databases contain remote similarity search agents for returning similarity scores and results to the similarity search engine without a requirement for relocating the searched information from the disparate databases.
